(19) United States
(12) Patent Application Publication
(10) Pub. No.: US 2008/0088471 A1
(43) Pub. Date: Apr. 17, 2008

(54) Simplistic remote control device for an anatomically challenged individual

(76) Inventor: Wilma J. Trappler, Addison, NY (US)

Correspondence Address: RICHARD L. MILLER, 12 PARKSIDE DRIVE, DIX HILLS, NY, 11746, US

(21) Appl. No.: 11/540,396

(22) Filed: Sep. 29, 2006

(51) Int. Cl. G09B 21/00

(52) U.S. Cl. 340/825.19; 398/106; 340/825.72; 341/176; 348/734

(57) ABSTRACT

A simplistic remote control device for an anatomically challenged individual. A plurality of pushbuttons are disposed on a housing and are used by the anatomically challenged individual. An infrared LED transmitter is visible through the housing and sends infrared signals to a remote controlled device associated with the remote control device. The plurality of pushbuttons are oversized and consist of a flourescent red bold ON/OFF indicia pushbutton, a flourescent orange bold VOLUME indicia pushbutton, and a flourescent green bold CHANNEL indicia pushbutton for convenience of the anatomically challenged individual. The housing has a nose with a tip in which the infrared LED transmitter is disposed and is visible through. The nose of the housing has a through bore therethrough to attach the remote control device to articles convenient for the anatomically challenged individual and which is set back from, so as not to interfere with, the infrared LED transmitter.

### BACKGROUND OF THE INVENTION

1. Field of the Invention

The present invention relates to a remote control device, and more particularly, the present invention relates to a simplistic remote control device for an anatomically challenged individual.

2. Description of the Prior Art

Numerous innovations for remote control related devices have been provided in the prior art that will be described. Even though these innovations may be suitable for the specific individual purposes to which they address, however, they differ from the present invention.

A FIRST EXAMPLE, U.S. Pat. No. 4,680,790, Issued on Jul. 14, 1987, to Packard Et Al. teaches a bedside control module for healthcare stations and the like, of the type generally having a bed, and at least two control functions, such as bed adjustments, nurse call, telephone, television, radio, lights, and other such accessories. The control module includes a dual-sided control panel that is supported by an arm at a position adjacent to the bed for access by the user. Both sides of the control panel include manually-operable controllers for operating the various control functions. The control panel is rotatably mounted on the support arm for manual rotation about a normally, generally vertical axis that is oriented to selectively and sequentially present the opposite sides of the control panel to the user to regulate the various control functions.

A SECOND EXAMPLE, U.S. Pat. No. 5,408,044, Issued on Apr. 18, 1995, to Spiegel teaches a television remote control adaptor, including a protective housing for receiving the remote control unit and oversized pushbuttons for manipulating the remote control unit from outside of the adaptor. The television remote control is held in precise orientation of the adaptor by a spring retainer clip. An aperture at one end of the housing permits the infrared transmitters of the remote control unit to activate a television set. An open mesh is attached across the closed face of the housing adjacent to the remote control pushbuttons. Four or five adaptor buttons are attached to the outside of the mesh and held in place by a pair of leg protrusions that engage the mesh. A longer, thinner protrusion, also attached to the adaptor button, passes through the mesh and contacts the underlying remote control pushbuttons when the adaptor button is depressed by the user. The housing not only protects the remote control unit but it also makes it possible for the pushbuttons to be manipulated by individuals having limited visual acuity or manual dexterity.

A THIRD EXAMPLE, U.S. Patent Office Document No. 2004/0248567 A1, Published on Dec. 9, 2004, to Sigurdsson Et Al. teaches a control console for a video player, such as a DVD player. The console includes a first group of sensors and a second group of sensors and a communication device for transmitting control signals to the DVD player. Several cards are provided. One card is arranged adjacent the console covering a surface area thereof. The card has slots for cooperation with the first group of sensors. The card also has figures covering the second group of sensors. When a child presses one of the figures, the corresponding button is activated and emits a signal for control of the DVD player. In programming mode, the signal controls the console itself for adapting the console to the DVD player actually used. There is also a programming mode using the DVD player's normal remote control for learning purpose.

A FOURTH EXAMPLE, U.S. Patent Office Document No. 2006/0007014 A1, Published on Jan. 12, 2006, to Orlando teaches an appliance remote control, with a video display, control buttons, with each control button having a staged depressable switch. The appliance remote control is for any remote controlled appliance, such as a TV, VCR, or DVD with the addition of a video display, staged switching for each button, and internal control logic. A person will now have the flexibility to view remote control buttons clearly under otherwise poor visible conditions, and decide if the function of the button is to be selected or not. Touching or slightly depressing a remote control button will display the control button function on the video display. The control function is not passed to the remote controlled appliance at this time. A preview of the button function will be clearly presented on the video display. For example, if the “2” button is slightly depressed, a large character “2” will be displayed on the video display. Anyone with poor eyesight or in a low lighted room will now be able to verify on the bright clear display if this is the button to be selected. If it is the button to be selected, the button is simply depressed completely for the selection to be completed. The button may also be released for no action to be taken. To further enhance, a preview display of any control button may also be displayed on the remote controlled appliance video display.

It is apparent that numerous innovations for remote control related devices have been provided in the prior art that are adapted to be used. Furthermore, even though these innovations may be suitable for the specific individual purposes to which they address, however, they would not be suitable for the purposes of the present invention as heretofore described.

### SUMMARY OF THE INVENTION

Accordingly, it is an object of the present invention to provide a simplistic remote control device for an anatomically challenged individual that avoids the disadvantages of the prior art.

Briefly stated, another object of the present invention is to provide a simplistic remote control device for an anatomically challenged individual. A plurality of pushbuttons are disposed on a housing and are used by the anatomically challenged individual. An infrared LED transmitter is visible through the housing and sends infrared signals to a remote controlled device associated with the remote control device. The plurality of pushbuttons are oversized and consist of a flourescent red bold ON/OFF indicia pushbutton, a flourescent orange bold VOLUME indicia pushbutton, and a flourescent green bold CHANNEL indicia pushbutton for convenience of the anatomically challenged individual. The housing has a nose with a tip in which the infrared LED transmitter is disposed and is visible through. The nose of the housing has a through bore therethrough to attach the remote control device to articles convenient for the anatomically challenged individual and which is set back from, so as not to interfere with, the infrared LED transmitter.

The novel features which are considered characteristic of the present invention are set forth in the appended claims. The invention itself, however, both as to its construction and its method of operation, together with additional objects and advantages thereof, will be best understood from the following description of the specific embodiments when read and understood in connection with the accompanying drawing.

### BRIEF DESCRIPTION OF THE DRAWING

FIG. 1 is a diagrammatic perspective view of the simplistic remote control device of the present invention utilized by an anatomically challenged individual;

FIG. 2 is an enlarged diagrammatic perspective view of the area generally enclosed by the dotted curve identified by ARROW 2 in FIG. 1 of the simplistic remote control device of the present invention;

FIG. 3 is an enlarged diagrammatic top plan view taken generally in the direction of ARROW 3 in FIG. 1;

FIG. 4 is a diagrammatic side elevational view taken generally in the direction of ARROW 4 in FIG. 3;

FIG. 5 is a diagrammatic bottom plan view taken generally in the direction of ARROW 5 in FIG. 4;

FIG. 6 is a diagrammatic front end view taken generally in the direction of ARROW 6 in FIG. 5; and

FIG. 7 is a diagrammatic back end view taken generally in the direction of ARROW 7 in FIG. 5.

### LIST OF REFERENCE NUMERALS UTILIZED IN THE DRAWING

10 simplistic remote control device of present invention for anatomically challenged individual
12 anatomically challenged individual
14 housing for fitting comfortably in hand of anatomically challenged individual 12
16 plurality of pushbuttons for use by anatomically challenged individual 12
18 infrared LED transmitter for sending infrared signals to remote controlled device associated with remote control device 10
20 flourescent red bold ON/OFF indicia pushbutton of plurality of pushbuttons 16 for convenience of anatomically challenged individual 12
22 flourescent orange bold VOLUME indicia pushbutton of plurality of pushbuttons 16 for convenience of anatomically challenged individual 12
24 flourescent green bold CHANNEL indicia pushbutton of plurality of pushbuttons 16 for convenience of anatomically challenged individual 12
28 top surface of housing 14
30 back surface of housing 14
32 nose of housing 14
34 tip of nose 32 of housing 14
36 through bore through nose 32 of housing 14 for attaching remote control device 10 to articles convenient for anatomically challenged individual 12
38 door in back surface 30 of housing 14 for accessing batteries contained within housing 14 to power remote control device 10

### DETAILED DESCRIPTION OF THE PREFERRED EMBODIMENT

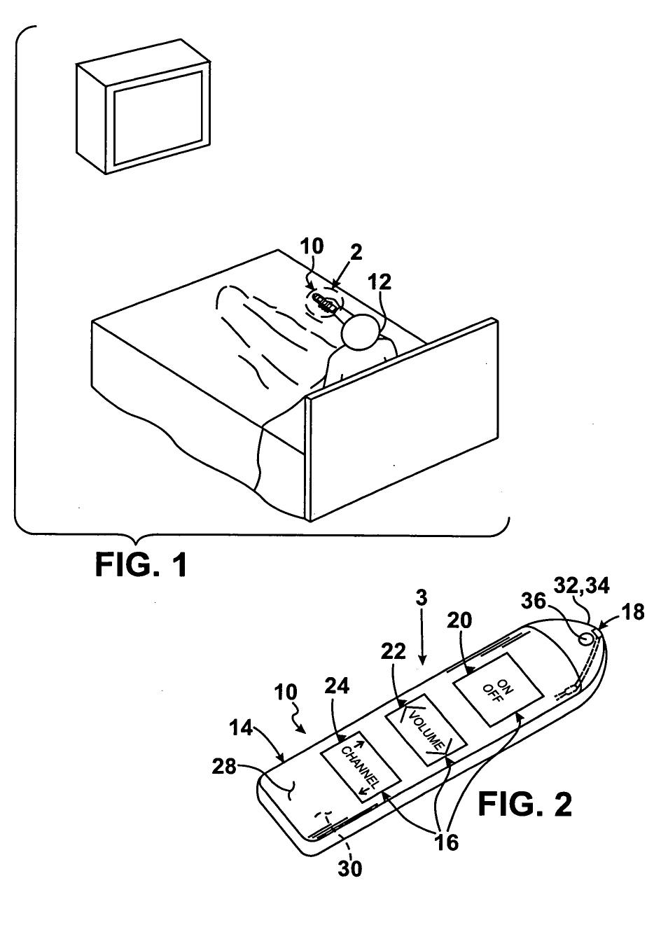

Referring now to the figures, in which like numerals indicate like parts, and particularly to FIG. 1, which is a diagrammatic perspective view of the simplistic remote control device of the present invention utilized by an anatomically challenged individual, the simplistic remote control device of the present invention is shown generally at 10 for an anatomically challenged individual 12, such as visual, clarity, and dexterity impaired.

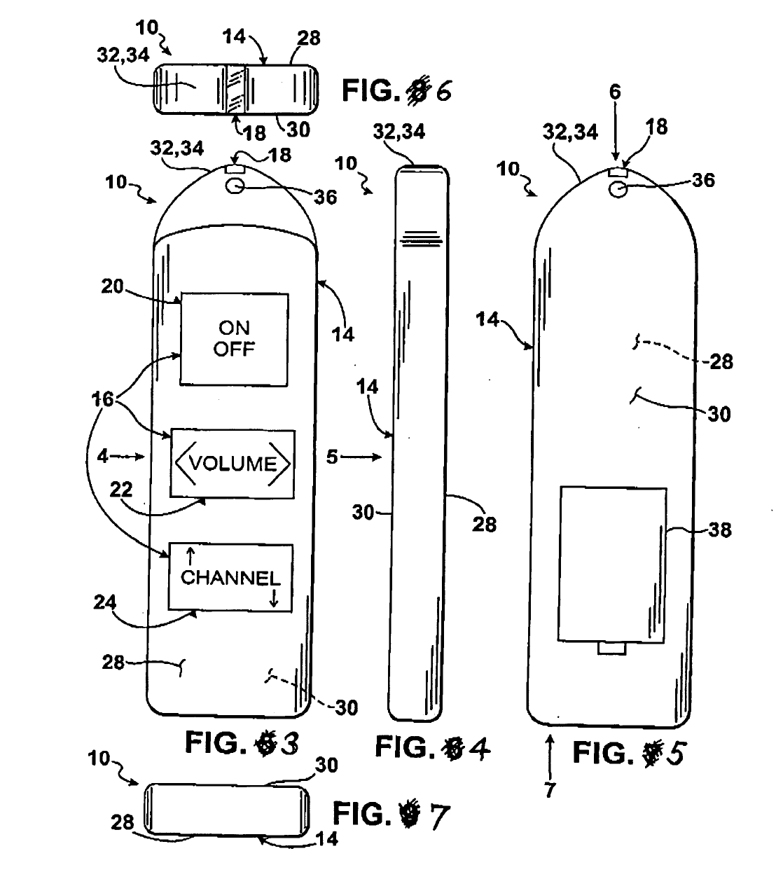

The configuration of the simplistic remote control device 10 can best be seen in FIGS. 2-7, which are, respectively, an enlarged diagrammatic perspective view of the area generally enclosed by the dotted curve identified by ARROW 2 in FIG. 1 of the simplistic remote control device of the present invention, an enlarged diagrammatic top plan view taken generally in the direction of ARROW 3 in FIG. 1, a diagrammatic side elevational view taken generally in the direction of ARROW 4 in FIG. 3, a diagrammatic bottom plan view taken generally in the direction of ARROW 5 in FIG. 4, a diagrammatic front end view taken generally in the direction of ARROW 6 in FIG. 5, and a diagrammatic back end view taken generally in the direction of ARROW 7 in FIG. 5, and as such, will be discussed with reference thereto.

The remote control device 10 comprises a housing 14, a plurality of pushbuttons 16, and an infrared LED transmitter 18. The plurality of pushbuttons 16 are disposed on the housing 14 and are for use by the anatomically challenged individual 12. The infrared LED transmitter 18 is visible through the housing 14 and is for sending infrared signals to a remote controlled device associated with the remote control device 10.

The plurality of pushbuttons 16 are oversized and consist only of a flourescent red bold ON/OFF indicia pushbutton 20, a flourescent orange bold VOLUME indicia pushbutton 22, and a flourescent green bold CHANNEL indicia pushbutton 24 for convenience of the anatomically challenged individual 12. In at least one embodiment of the remote control device 10 at least one of the pushbuttons 16 has a dimension of at least ¾ of an inch on along an edge of a button so as to facilitate the ease of location of the button by a user.

The housing 14 is slender, elongated, thin, flat, and rounded edges for fitting comfortably in a hand of the anatomically challenged individual 12, and has a top surface 28, a back surface 30, and a nose 32.

The plurality of pushbuttons 16 are disposed on the top surface 28 of the housing 14.

The nose 32 of the housing 14 is convex and tapers to a tip 34. The infrared LED transmitter 18 is disposed in, and is visible through, the tip 34 of the nose 32 of the housing 14.

The nose 32 of the housing 14 has a through bore 36 therethrough for attaching the remote control device 10 to articles convenient for the anatomically challenged individual 12. The through bore 36 through the nose 32 of the housing 14 is set back from, so as not to interfere with, the infrared LED transmitter 18.

The back surface 30 of the housing 14 has a door 38. The door 38 in the back surface 30 of the housing 14 is replaceable and is for accessing batteries contained within the housing 14 to power the remote control device 10.

It will be understood that each of the elements described above, or two or more together, may also find a useful application in other types of constructions differing from the types described above.

While the invention has been illustrated and described as embodied in a simplistic remote control device for an anatomically challenged individual, however, it is not limited to the details shown, since it will be understood that various omissions, modifications, substitutions and changes in the forms and details of the device illustrated and its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute characteristics of the generic or specific aspects of this invention.

The invention claimed is:

1. A simplistic remote control device for an anatomically challenged individual, comprising:
a) a housing;
b) a plurality of pushbuttons; and
c) an infrared LED transmitter;
wherein said plurality of pushbuttons are disposed on said housing;
wherein said plurality of pushbuttons are for use by the anatomically challenged individual;
wherein said infrared LED transmitter is visible through said housing; and
wherein said infrared LED transmitter is for sending infrared signals to a remote controlled device associated with said remote control device.

2. The device of claim 1, wherein said plurality of pushbuttons are oversized for convenience of the anatomically challenged individual.

3. The device of claim 1, wherein said plurality of pushbuttons consist of a flourescent red bold ON/OFF indicia pushbutton, a flourescent orange bold VOLUME indicia pushbutton, and a flourescent green bold CHANNEL indicia pushbutton for convenience of the anatomically challenged individual.

4. The device of claim 1, wherein said housing is slender, elongated, thin, flat, and rounded edges for fitting comfortably in a hand of the anatomically challenged individual.

5. The device of claim 1, wherein said housing has a top surface; and
wherein said plurality of pushbuttons are disposed on said top surface of said housing.

6. The device of claim 1, wherein said housing has a nose;
wherein said nose of said housing is convex; and
wherein said nose of said housing tapers to a tip.

7. The device of claim 6, wherein said infrared LED transmitter is disposed in said tip of said nose of said housing; and
wherein said infrared LED transmitter is visible through said tip of said nose of said housing.

8. The device of claim 6, wherein said nose of said housing has a through bore therethrough; and
wherein said through bore through said nose of said housing is for attaching said remote control device to articles convenient for the anatomically challenged individual.

9. The device of claim 8, wherein said through bore through said nose of said housing is set back from, so as not to interfere with, said infrared LED transmitter.

10. The device of claim 1, wherein said housing has a back surface;
wherein said back surface of said housing has a door;
wherein said door in said back surface of said housing is replaceable; and
wherein said door in said back surface of said housing is for accessing batteries contained within said housing to power said remote control device.

11. A simplistic remote control device for an anatomically challenged individual, comprising:
a) a housing;
b) a plurality of pushbuttons; and
c) an infrared LED transmitter;
wherein said plurality of pushbuttons are disposed on said housing;
wherein said plurality of pushbuttons are for use by the anatomically challenged individual;
wherein at least one of said pushbuttons has an edge dimension of at lease ¾ of an inch.

12. The device of claim 11, wherein said plurality of pushbuttons are oversized for convenience of the anatomically challenged individual.

13. The device of claim 11, wherein said plurality of pushbuttons consist of a flourescent red bold ON/OFF indicia pushbutton, a flourescent orange bold VOLUME indicia pushbutton, and a flourescent green bold CHANNEL indicia pushbutton for convenience of the anatomically challenged individual.

14. The device of claim 11, wherein said housing is slender, elongated, thin, flat, and rounded edges for fitting comfortably in a hand of the anatomically challenged individual.

15. The device of claim 11, wherein said housing has a top surface; and
wherein said plurality of pushbuttons are disposed on said top surface of said housing.

16. The device of claim 11, wherein said housing has a nose;
wherein said nose of said housing is convex; and
wherein said nose of said housing tapers to a tip.

17. The device of claim 16, wherein said infrared LED transmitter is disposed in said tip of said nose of said housing; and
wherein said infrared LED transmitter is visible through said tip of said nose of said housing.

18. The device of claim 16, wherein said nose of said housing has a through bore therethrough; and
wherein said through bore through said nose of said housing is for attaching said remote control device to articles convenient for the anatomically challenged individual.

19. The device of claim 18, wherein said through bore through said nose of said housing is set back from, so as not to interfere with, said infrared LED transmitter.

20. The device of claim 11, wherein said housing has a back surface;
wherein said back surface of said housing has a door;
wherein said door in said back surface of said housing is replaceable; and
wherein said door in said back surface of said housing is for accessing batteries contained within said housing to power said remote control device.
